(19) United States
(12) Patent Application Publication
(10) Pub. No.: US 2025/0104882 A1
(43) Pub. Date: Mar. 27, 2025

(54) Cask Storing Radioactive Nuclear Material and for Cooling Liquified Radiation Shielding Material by Controlling Flow Between Primary and Expansion Tanks

(71) Applicant: NAC International Inc., Norcross, GA (US)

(72) Inventors: Holger Pfeifer, Norcross, GA (US); Michael Yaksh, Lilburn, GA (US); George Carver, Peachtree Corners, GA (US); Jay Wellwood, Peachtree Corners, GA (US)

(21) Appl. No.: 18/598,369

(22) Filed: Mar. 7, 2024

Related U.S. Application Data
(60) Provisional application No. 63/540,428, filed on Sep. 26, 2023.

(51) Int. Cl. G21F 5/10; G21F 1/02

(52) U.S. Cl. CPC G21F 5/10; G21F 1/023

(57) ABSTRACT

Disclosed are embodiments of a cask for storing hazardous nuclear material with automatic control and cooling of liquified radiation shielding material flowing between primary and expansion tanks to accommodate for internal temperature changes in the primary tank. The cask contains a container with the hazardous radioactive material that emits radiation. The primary tank surrounds the container and has liquified radiation shielding material. The expansion tank is in fluid communication with the primary tank via a siphon tube and also has liquified radiation shielding material and a gaseous fluid pocket that enables expansion and contraction of the liquified radiation shielding material in both the primary and expansion tanks. The siphon tube enables communication of liquified radiation shielding material between the primary and expansion tanks based upon a temperature change in the liquified radiation shielding material in the primary tank.

### CLAIM OF PRIORITY

This application claims the benefit of and priority to provisional application No. 63/540,428, filed Sep. 26, 2023, under attorney docket 61404-8220, which is incorporated here by reference in its entirely.

### FIELD OF THE INVENTION

The embodiments of the present disclosure generally relate to storage and transportation of hazardous radioactive materials and, more particularly, to a cask for storing hazardous nuclear material and for cooling liquified radiation shielding material used for absorbing nuclear radiation from the hazardous nuclear material.

### BACKGROUND

Due to the radioactive decay process, nuclear materials produce heat. This heat is then transmitted to liquified radiation shielding material contained within an annular primary tank adjacent to an inner structure of an elongated, generally cylindrical, transfer cask. As the liquified radiation shielding material contained within the primary tank heats up, it will expand, thereby undesirably increasing the internal pressure of the primary tank.

In order to prevent permanent damage to the primary tank due to an increase in internal pressure, a relief device, for example, a pressure relief valve, rupture disc, a combination of the foregoing, etc., is typically required to automatically reduce internal pressure in order to preserve the integrity of the primary tank by discharging the excess liquified radiation shielding material.

However, if after opening the relief device, the relief device fails to automatically close, then a loss of liquified radiation shielding material may occur, resulting in an undesirable increase in hazardous radiation levels around the transfer cask. Similarly, if the transfer cask containing the container filled with radioactive nuclear material is exposed to a severe external event that increases the temperature of the primary tank, then an increase in internal pressure can occur. Without the relief device, the primary tank can rupture, thereby resulting in an undesirable loss of the liquified radiation shielding material and an undesirable increase in hazardous radiation levels near the transfer cask.

### SUMMARY OF THE INVENTION

Various embodiments of radioactive nuclear material cask and method are disclosed for storing hazardous nuclear material and for cooling liquified radiation shielding material used for absorbing nuclear radiation from the hazardous nuclear material. Specifically, the cask automatically controls liquified radiation shielding material flowing between a primary tank and an expansion tank in order to accommodate internal temperature changes, particularly an increase, in the primary tank. The cask can be, for example but not limited to, a transfer cask that is designed for transporting a container having radioactive nuclear material.

One embodiment, among others, is a cask having a container that contains the hazardous nuclear material, a primary tank, and an expansion tank. The primary tank is situated in close proximity to the container. The primary tank contains liquified radiation shielding material that captures radiation that is emitted from the container. The expansion tank also contains liquified radiation shielding material. The expansion tank is in fluid communication with the primary tank via, for example but not limited to, a syphon tube, in order to (a) permit a part of the liquified radiation shielding material to flow from the primary tank into the expansion tank when a temperature of the material in the primary tank increases, (b) allow the liquified radiation shielding material to cool in the expansion tank, and (c) as the liquified radiation shielding material is cooled, permit the cooled liquified radiation shielding material to flow from the expansion tank into the primary tank.

Another embodiment, among others, is a method. The method can be summarized by the following steps: storing hazardous nuclear material in a container; capturing the nuclear radiation with liquified radiation shielding material in a primary tank surrounding the container; transferring a part of the liquified radiation shielding material from the primary tank into an expansion tank when a temperature of the liquified radiation shielding material in the primary tank increases; allowing the liquified radiation shielding material to cool in the expansion tank; and as the liquified radiation shielding material is cooled, permitting the cooled liquified radiation shielding material to flow from the expansion tank back into the primary tank.

Other embodiments, apparatus, methods, features, and advantages of the present invention will be apparent to one with skill in the art upon examination of the following drawings and detailed description. It is intended that all such additional embodiments, apparatus, methods, features, and advantages be included within this disclosure, be within the scope of the present invention, and be protected by the accompanying claims.

### BRIEF DESCRIPTION OF THE DRAWINGS

Many aspects of the disclosure can be better understood with reference to the accompanying drawings. The components in the drawings are not necessarily to scale, emphasis instead being placed upon clearly illustrating the principles of the present disclosure.

FIG. 1 is a side view of a cask for storing hazardous nuclear material and having automatic control of liquified shielding material that flows between a primary tank and an expansion tank in order to accommodate temperature changes in the primary tank.

FIG. 2 is a side view of the cask of FIG. 1, showing a liquified radiation shielding material in an expansion tank.

FIG. 3 is a side view of the cask of FIG. 2, showing an increase in the level of the liquified radiation shielding material in the expansion tank when the temperature in the primary tank increases.

FIG. 4 is a side view of the cask of FIG. 3, showing a decrease in the level of the liquified radiation shielding material in the expansion tank when the temperature in the primary tank decreases.

### DETAILED DESCRIPTION OF THE PREFERRED EMBODIMENT(S)

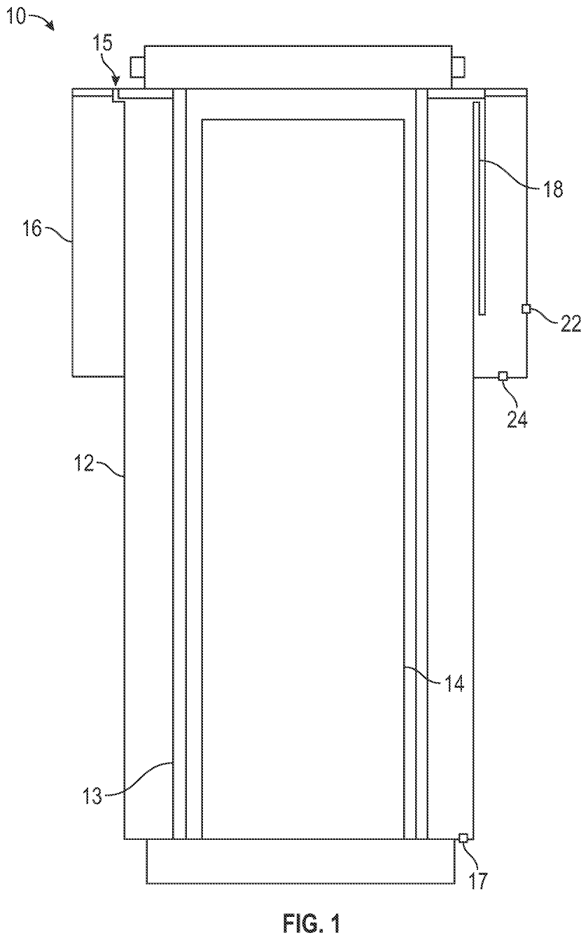

As shown in FIGS. 1 through 4, a cask 10 is designed to store hazardous nuclear material that is contained within a sealed container 14 situated therein. The container 14 emits hazardous radiation.

In the preferred embodiment, the cask 10 is a transfer cask that is designed for transporting the container 14. The design of the transfer cask is well known in the art. The cask 10 has a sealed elongated cylindrical body extending between a top end and a bottom end. The cask 10 includes a primary tank 12 having an elongated cylindrical body extending between a top end and a bottom end. The primary tank body has liquified radiation shielding material therein. In the preferred embodiment, the liquified shielding material is clean water. The primary tank 12 is situated annularly around the cylindrical body of the cask body.

By use of an expansion tank 16 that is in fluid communication with the primary tank 12, the cask 10 permits cooling and automatic control of liquified radiation shielding material 11 that is contained in an external primary tank 12 adjacent to an inner wall 13 of the cask 10 to accommodate for changes in temperature within the primary tank 12. The expansion tank 16 has an elongated cylindrical body extending between a top end and a bottom end. The expansion tank body is situated annularly around the cylindrical body of the primary tank 12. In the preferred embodiment, the expansion tank 16 extends along a substantially small part of a length associated with the primary tank body.

The liquified radiation shielding material 11 is introduced into the primary tank 12 at a fill port 15 near the top of the cask 10 and is drained from the primary tank 12 at a drain port 17 near the bottom of the cask 10. The presence of the liquified radiation shielding material 11 in the primary tank 12 is essential to preventing hazardous radiation levels adjacent to the cask 10.

The expansion tank 16 has a vertically-oriented siphon tube 18 that is used to transport the liquified radiation shielding material 11 to and from the primary tank 12 respectively from and to the expansion tank 16, a telltale fill port 22, and a drain port 24 that permits liquified radiation shielding material 11 to be drained from the expansion tank 16. The siphon tube 18 extends between and is in fluid communication with the primary and expansion tanks 12, 16. The siphon tube 18 enables communication of liquified radiation shielding material between the primary and expansion tanks 12, 16 based upon a pressure change and resulting temperature change within the liquified radiation shielding material in the primary tank 12.

The expansion tank 16 with the liquified radiation shielding material 11 essentially serves as a reserve volume that replaces the pressure relieving device(s) (pressure relief valve, rupture disc, or combination thereof) that is typically implemented in prior art embodiments and automatically accommodates the expansion and contraction of the liquified radiation shielding material 11 from the primary tank 12 during the increase and decrease, respectively, in temperature condition. As the temperature of the liquified radiation shielding material 11 is reduced, the liquified radiation shielding material 11 contracts, thereby occupying less volume. This contraction of the liquified radiation shielding material 11 creates a siphon effect, drawing the liquified radiation shielding material 11 from the expansion tank 16 back into the primary tank 12, thereby preventing a void(s) in the primary tank 12 that would result in an increase in hazardous radiation levels around the cask 10.

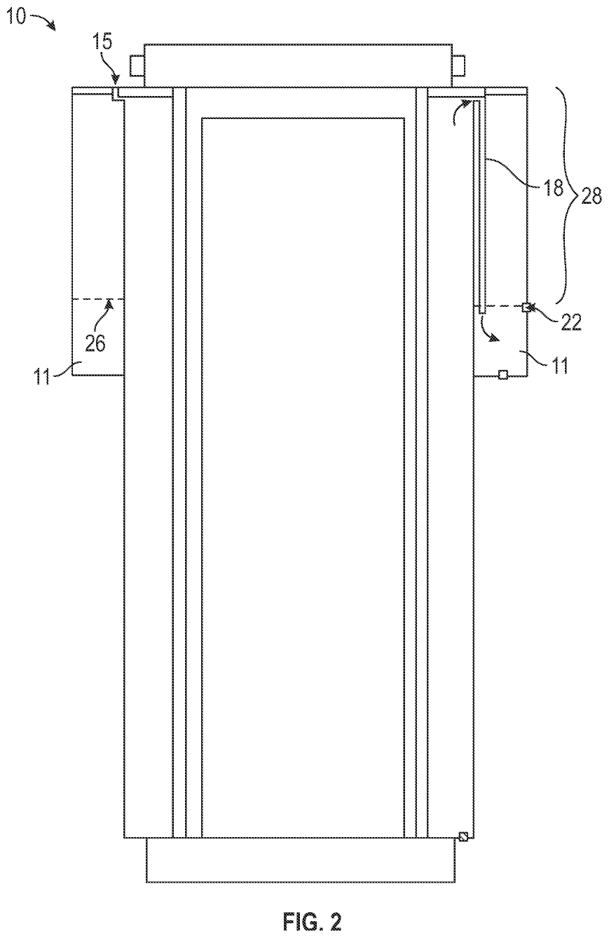

As illustrated in FIG. 2, in the preferred embodiment, the primary tank 12 and expansion tank 16 can both be filled at the same time with liquified radiation shielding material 11 that is introduced through the primary tank fill port 15 until the level 26 in the expansion tank 16 is achieved through the telltale fill port 22 on the expansion tank 16.

Upon completion of filling the primary tank 12 and the expansion tank 16, plugs are installed in both the primary tank fill port 15 and telltale fill port 22. This results in a gaseous fluid pocket (i.e., air or other desirable gas) 28 within the expansion tank 16 that serves as the compensatory volume specifically designed to accommodate the controlled expansion and contraction of the liquified radiation shielding material 11 in both the primary tank 12 and expansion tank 16.

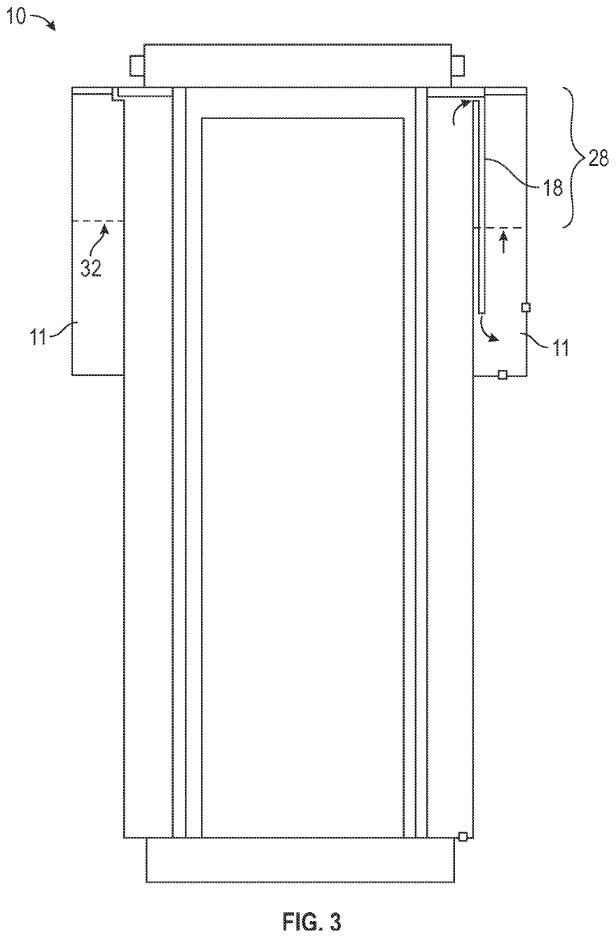

As the temperature of the liquified radiation shielding materials increases, the material 11 expands. As the material 11 expands, the material 11 overflows into the expansion tank 16 through the siphon tube 18, thereby preventing the increase in internal pressure of the primary tank 12. As shown in FIG. 3, the level 26 of the liquified radiation shielding material 11 rises within the expansion tank 16 to a prescribed new higher level 32 and slightly higher internal pressure within the expansion tank 16. This preserves the integrity of the primary tank 12, thereby eliminating the need for a pressure relief valve, rupture disc, etc.

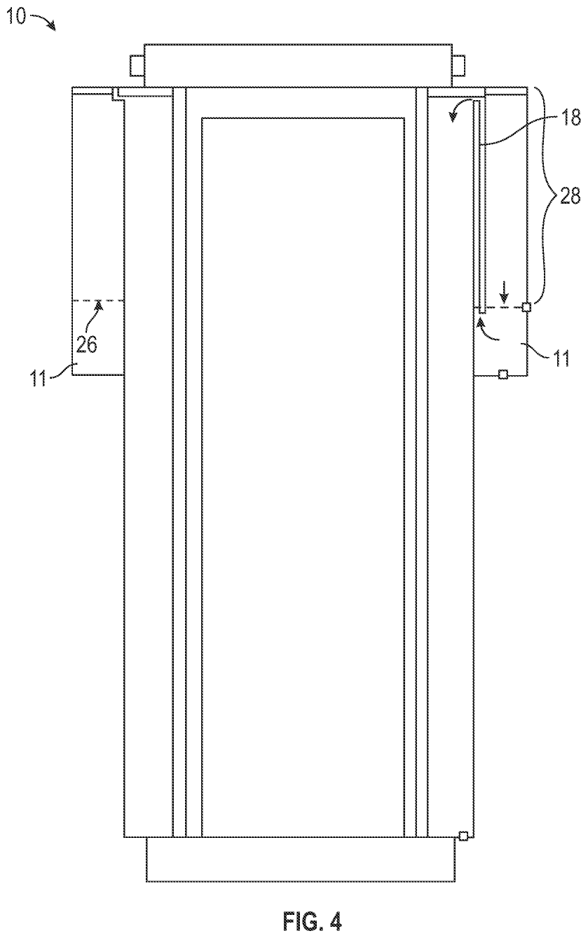

As the temperature of the liquified radiation shielding material 11 in the expansion tank 16 decreases, it contracts. As material 11 contracts, the material 11 is siphoned back into primary tank 12 through the siphon tube 18, thereby preventing a void(s) within the primary tank 12. As a consequence, as shown in FIG. 4, the level 32 (FIG. 3) of the liquified radiation shielding material 11 is lowered within the expansion tank 16 back to the prescribed original level 26.

As the temperature of the liquified radiation shielding material 11 in the expansion tank 16 decreases, the internal pressure is also lowered due to the expanding compensatory volume 28 within the expansion tank 16, forcing the return of the liquified radiation shielding material 11 back into the primary tank 12, which assures that the increase in radiation levels is not experienced near the cask 10 due to a void(s) in the primary tank 12 containing the liquified radiation shielding material 11.

The present disclosure also provides a method that can be summarized by the following steps: storing hazardous nuclear material in a container 13 or 14; capturing the nuclear radiation with liquified radiation shielding material 11 in a primary tank 12 surrounding the container 14; transferring a part of the liquified radiation shielding material 11 from the primary tank 12 into an expansion tank 16 when a temperature of the liquified radiation shielding material 11 in the primary tank 12 increases; allowing the liquified radiation shielding material 11 to cool in the expansion tank 16; and as the liquified radiation shielding material 11 is cooled, permitting the cooled liquified radiation shielding material 11 to flow from the expansion tank 16 back into the primary tank 12.

Finally, it should be emphasized that the above-described embodiment(s) of the present invention is merely a possible nonlimiting example of an implementation, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention.

As an example of a variation, the expansion tank 16 may be placed at any location along the longitudinal body of the cask 10 and can extend any distance along the longitudinal body (from the entire length or a portion, as in the preferred embodiment).

As another example, the primary tank 12 and/or the expansion tank 16 may be implemented with multiple separate tanks, if desired.

As another example, the cross section of the primary tank 12 and the expansion tank 16 taken along the respective longitudinal body need not be circular as it is in the preferred embodiment but instead can be a different shape, for example but not limited to, square, polygonal, etc.

At least the following is claimed:

1. A cask for storing hazardous nuclear material and for cooling liquified radiation shielding material used for absorbing nuclear radiation from the hazardous nuclear material, the cask comprising:
a container that contains the hazardous nuclear material;
a primary tank situated in close proximity to the container, the primary tank containing liquified radiation shielding material that captures radiation that is emitted from the container; and
an expansion tank containing liquified radiation shielding material, the expansion tank in fluid communication with the primary tank to (a) permit a part of the liquified radiation shielding material to flow from the primary tank into the expansion tank when a temperature of the material in the primary tank increases, (b) allow the liquified radiation shielding material to cool in the expansion tank, and (c) as the liquified radiation shielding material is cooled, permit the cooled liquified radiation shielding material to flow from the expansion tank into the primary tank.

2. The cask of claim 1, wherein:
the cask has an elongated cylindrical body extending between a top end and a bottom end, the body containing the container with hazardous radioactive material;
the primary tank has an elongated cylindrical body extending between a top end and a bottom end, the primary tank body having liquified radiation shielding material therein, the primary tank situated annularly around the cylindrical body of the cask body; and
the expansion tank has an elongated cylindrical body extending between a top end and a bottom end, the expansion tank body having liquified radiation shielding material therein, the expansion tank situated annularly around the cylindrical body of the primary tank; and further comprising:
a siphon tube in fluid communication with the primary and expansion tanks, the siphon tube enabling communication of liquified radiation shielding material between the primary and expansion tanks based upon a temperature change within the liquified radiation shielding material in the primary tank.

3. The cask of claim 2, wherein the primary tank includes a fill port and a drain port and wherein the expansion tank includes a fill port and a drain port.

4. The cask of claim 3, wherein each of the ports is closed with a respective plug.

5. The cask of claim 2, wherein the expansion tank extends along a substantially small part of a length associated with the primary tank body.

6. The cask of claim 2, wherein the siphon tube has an elongated tubular body extending vertically between a high end and a low end, the high end being open to and in fluid communication with the primary tank, the low end being open to and in fluid communication with the expansion tank.

7. The cask of claim 2, wherein the expansion tank comprises a gaseous fluid pocket over the liquified radiation shielding material, the fluid pocket enables controlled expansion and contraction of the liquified radiation shielding material in both the primary and expansion tanks.

8. A cask for storing hazardous nuclear material and for cooling liquified radiation shielding material used for absorbing nuclear radiation from the hazardous nuclear material, the cask comprising:
an elongated cylindrical body extending between a top end and a bottom end, the body having a container with hazardous radioactive material;
a primary tank having an elongated cylindrical body extending between a top end and a bottom end, the primary tank body having liquified radiation shielding material therein, the primary tank situated annularly around the cylindrical body of the cask body;
an expansion tank having an elongated cylindrical body extending between a top end and a bottom end, the expansion tank body having liquified radiation shielding material therein, the expansion tank situated annularly around the cylindrical body of the primary tank; and
a siphon tube in fluid communication with the primary and expansion tanks, the siphon tube enabling communication of liquified radiation shielding material between the primary and expansion tanks based upon a temperature change within the liquified radiation shielding material in the primary tank.

9. The cask of claim 8, wherein the primary tank includes a fill port and a drain port and wherein the expansion tank includes a fill port and a drain port.

10. The cask of claim 9, wherein each of the ports is closed with a respective plug.

11. The cask of claim 8, wherein the expansion tank extends along a substantially small part of a length associated with the primary tank body.

12. The cask of claim 8, wherein the siphon tube has an elongated tubular body extending vertically between a high end and a low end, the high end being open to and in fluid communication with the primary tank, the low end being open to and in fluid communication with the expansion tank.

13. The cask of claim 8, wherein the expansion tank comprises a gaseous fluid pocket over the liquified radiation shielding material, the fluid pocket enables controlled expansion and contraction of the liquified radiation shielding material in both the primary and expansion tanks.

14. A cask for storing hazardous nuclear material and for cooling liquified radiation shielding material used for absorbing nuclear radiation from the hazardous nuclear material, the cask comprising:
(a) an elongated cylindrical body extending between a top end and a bottom end, the body having a container with hazardous radioactive material;
(b) a primary tank having:
(1) an elongated cylindrical body extending between a top end and a bottom end, the body situated annularly around the cask body; and
(2) a fill port situated in close proximity the top of the body;
a drain port situated in close proximity to the bottom of the body; and
liquified radiation shielding material situated within the primary tank body;
(c) an expansion tank having:
(1) an elongated cylindrical body extending between a top end and a bottom end, the body situated annularly around the primary tank body; and
(2) liquified radiation shielding material situated with the expansion tank body; and
(d) siphon tube having an elongated tubular body extending vertically between a high end and a low end, the high end being open to and in fluid communication with the primary tank, the low end being open to and in fluid communication with the expansion tank, the siphon tube enabling communication of liquified radiation shielding material between the primary and expansion tanks based upon a temperature change within the liquified radiation shielding material in the primary tank.

15. The cask of claim 14, wherein the expansion tank extends along a substantially small part of a length associated with the primary tank body.

16. The cask of claim 14, wherein each of the ports is closed with a respective plug.

17. The cask of claim 14, wherein the expansion tank comprises a gaseous fluid pocket over the liquified radiation shielding material, the fluid pocket enables controlled expansion and contraction of the liquified radiation shielding material in both the primary and expansion tanks.

18. A method for storing hazardous nuclear material and for cooling liquified radiation shielding material used for absorbing nuclear radiation, the method comprising:
(a) storing hazardous nuclear material in a container;
(b) capturing the nuclear radiation with liquified radiation shielding material in a primary tank surrounding the container;
(c) transferring a part of the liquified radiation shielding material from the primary tank into an expansion tank when a temperature of the liquified radiation shielding material in the primary tank increases;
(d) allowing the liquified radiation shielding material to cool in the expansion tank; and
(e) as the liquified radiation shielding material is cooled, permitting the cooled liquified radiation shielding material to flow from the expansion tank into the primary tank.

19. The method of claim 18, further comprising a cask that contains the container and wherein:
the primary tank surrounds the cask containing the container;
the expansion tank surrounds the primary tank; and
the expansion tank is in fluid communication with the primary tank by way of a siphon tube in order to perform the steps (c), (d), and (e).

20. The method of claim 19, wherein the expansion tank comprises a gaseous fluid pocket over the liquified radiation shielding material, the fluid pocket enabling controlled expansion and contraction of the liquified radiation shielding material in both the primary and expansion tanks.
